(19) United States
(12) Patent Application Publication
(10) Pub. No.: US 2004/0264495 A1
(43) Pub. Date: Dec. 30, 2004

(54) Contention tree resolution in a communication system

(76) Inventor: Sai Shankar Nandagopalan, Tarrytown, NY (US)

Correspondence Address: US Philips Corporation, Intellectual Property Department, PO Box 3001, Briarcliff Manor, NY, 10510, US

(21) Appl. No.: 10/495,288

(22) PCT Filed: Oct. 24, 2002
(86) PCT No.: PCT/IB02/04452

(30) Foreign Application Priority Data
Nov. 14, 2001 (EP) 01204345.1

(51) Int. Cl. H04J 3/02

(52) U.S. Cl. 370/462

(57) ABSTRACT

A method of contention resolution in a medium access control system, with particular application to an upstream link in a HFC network is disclosed. In the medium, data is transmitted in frames, each comprising a plurality of slots. At least two (and typically more) of these slots in each frame are contention slots. At least one contention slot in each frame is reserved for new arrivals to a contention tree that wish to access the channel capacity using contention resolution and at least one further contention slot is reserved for resolving contention if there is collision in the arrival slot. Arrivals that collide in the arrival slot contend for entry into the tree in the contention slots.

This invention relates to contention tree resolution in a communication system.

Consider an access system with a finite number of network terminations (NTs), each trying to exchange data with a central station, the so-called “head end” (HE). In a typical system, all of the NTs use the same channel for communication with the HE. The upstream communication channel is divided into time slots of fixed length. The length of the slot corresponds to a time, within which a fixed-length data packet can be sent (say, a packet of 64 bytes). A frame is defined as a sequence of a predetermined number (say, 18) of consecutive slots. It is normal for there to be at least two classes of slot identified as data slots and contention slots. A data slot is one that has been allocated to a particular NT in which to send data to the HE, and a contention slot is one that is free for any NT to use in order to request allocation of data slots. The number of data slots and contention slots in a frame is not fixed, but can be determined by the HE at the start of a frame.

When an NT wishes to send a block of data to the HE, it must first receive an allocation of data slots in which it is entitled to send data. This is done by means of a medium access control (MAC) protocol. In this procedure, the NT first has to send a request over the communication channel in a contention slot to the HE to request a number of data slots sufficient to contain the data. If the request is successful, the HE will send a message to the NT to identify the data slots that have been allocated to it.

Since contention slots are not allocated to a particular NT, in any one such slot, zero, one, or more than one NT may submit a request to the HE. When exactly one such request is received at the HE in a particular contention slot, it can be processed. However, if more than one request is received in a contention slot there is collision, none of the requests can be processed and all NTs must request again. This situation is referred to as “contention” and the procedure that is adopted to address this problem is called “contention resolution”.

The allocation of a single broadcast communication channel among a large number of independent users requires more advanced MAC protocols than simple time-division multiple access (TDMA). The reason is that TDMA provides low performance with respect to channel utilization, unless all the users are transmitting continuously. TDMA provides low access delay if and only if there are few users accessing the channel. Therefore, in 1970 the ALOHA protocol was introduced as a scheme that provides random access to the channel. Random access implies that two or more users may attempt to use the channel at the same time. However, simultaneous access must be prevented if errors in the channel are to be avoided. In the ALOHA protocol, if a collision (i.e. simultaneous access by more than one terminal) occurs, all terminals must abort their transmission and try again later, each one after a randomly chosen time. While the performance of the ALOHA protocol is adequate in many applications, it becomes very poor if the channel occupancy increases beyond a certain level.

Two principle approaches have been taken to improve upon the performance of the ALOHA protocol: carrier sense multiple access and contention resolution algorithms. This invention is related to the latter of these, and in particular to improvement upon the contention tree algorithm that was first proposed in the late 1970s.

In the case of hybrid fibre coaxial (HFC) networks, several MAC standards based on the contention tree algorithm have become available that ensure the interoperability between a HE and a set of NTs. The three major ones are IEEE 802.14 defined in IEEE 802.14 WG, Cable-TV access method and physical layer specification, Draft 3, Revision 3, Oct. 1998; DOCSIS 1.1 defined in MCNS Holdings, Data-Over-Cable Service Interface Specifications, Radio Frequency Interface Specification, Ref. Nr. SP-RFIv1.1-PIO1-990226 (Feb. 1999); and DVB/DAVIC defined in DVB, Digital Video Broadcasting (DVB); DVB interaction channel for Cable-TV distribution systems (CATV), working draft (version 2), Mar. 12, 1999, based on European Telecommunications Standard.

These existing algorithms can be typically classified as providing either a blocked tree or a non-blocked tree. In the case of a blocked tree, once a tree has been started, it is processed without interruption to its termination. Meanwhile, if new NTs attempt to enter the system, they find that no slot is available because they have all been assigned to tree completion. As soon as the tree completes, all of the waiting customers will enter the first available slot.

In the case of a non-blocked tree, a new NT can enter the tree without having to wait for the tree to be terminated. Thus, as each slot in the tree is being processed, it may happen that a new NT enters the tree to compete in that slot. If the slot is already occupied by a request from an existing NT, a new contention and therefore a new contention subtree will be generated.

An aim of this invention is to provide a mechanism for contention resolution in a contention tree that is more effective in use than existing contention resolution mechanisms and that has particular, but not exclusive, application to HFC networks.

From a first aspect, this invention provides a method of contention resolution in a medium access control system in which medium data is transmitted in frames, each comprising a plurality of slots, in which at least two slots in each frame are contention slots in which at least one contention slot in each frame is reserved for new arrivals to a contention tree that wish to access the channel capacity using contention resolution and in which at least one further contention slot is reserved for resolving contention if there is collision in the arrival slot.

Qualitatively, the invention can be considered as ameliorating two particular problems experienced with the existing systems discussed above. It avoids the potential for piling up of requests at the start of a blocked tree, while avoiding interference with existing entries that can occur in a non-blocked tree.

Any arrivals that collided in a particular arrival slot are typically only allowed to access the contention slot. Thus, neither a newly arriving request nor a request already on the tree can access the contention slot, thereby allowing a mechanism for new customer to enter the contention process without interrupting processing of the existing tree.

The number of arrival slots may be unequal to the number of contention slots. For example, the efficiency of the system may be enhanced if the number of contention slots is greater than the number of arrival slots, for example, by a factor of 2 or more. Modelling of the system suggests that there may advantageously be twice the number of contention slots as arrival slots. For example, in a system in which a frame has a total of eighteen slots, it may be advantageous to provide one arrival slot and two contention slots.

In a typical embodiment of the invention, each arrival and contention slot comprises a plurality (for example, three) mini-slots. In such embodiments, each arrival and contention slot is a tree access slot with three mini-slots. Each mini-slot is capable of carrying a request from a network terminal. However, when data is to be sent, an entire slot will normally be used.

The NTs whose requests that collided in the arrival slot may be grouped together into a super customer and sent into a queue, for example, a simple FIFO queue. Thereby, this group of users alone attempts collision resolution in the future contention slots. In addition, the requests belonging to a particular group choose one of the three mini-slots randomly in the tree algorithm. Mini-slots in the contention slot that contain at least one request are then processed in turn.

Thus, the service completion of a particular super customer occurs at the completion of a single free access tree process. Therefore, the service time of a super customer is the termination time of the tree. Since there is an exact number of slots (for example, one slot) reserved for tree access per frame, the system may acquire a customer at that initiation of a frame or we may not get a customer. (In this context, a customer refers to a group that collided in the arrival slot of the tree.)

A typical embodiment of the invention provides a method control to an upstream link in a public-access content distribution system. In particular, it has application to a HFC cable distribution system.

From a second aspect, this invention provides a medium access protocol that performs contention resolution by a method according to the first aspect of the invention. More specifically, this aspect of the invention may provide a medium access protocol for granting access to an upstream link in a HFC cable distribution system.

Form a third aspect, this invention provides a software system executable by the head end of a communication system for performing a medium access protocol according to the second aspect of the invention.

From a further aspect, the invention provides a public-access content distribution system comprising a head end and a plurality of network terminals, upstream communication between the network terminals and the head end being controlled by a protocol according to the second aspect of the invention.

From yet a further aspect, the invention provides a software system executable by the head end of a communication system for performing a medium access protocol according to the preceding aspect of the invention.

This invention further provides a Geom/G/1 queuing model, in which the access delay, waiting time and the throughput are easily determined and one can easily determine Ways to improve throughput compared to other models.

An embodiment of the invention will now be described in detail, by way of example, and with reference to the accompanying drawings, in which:

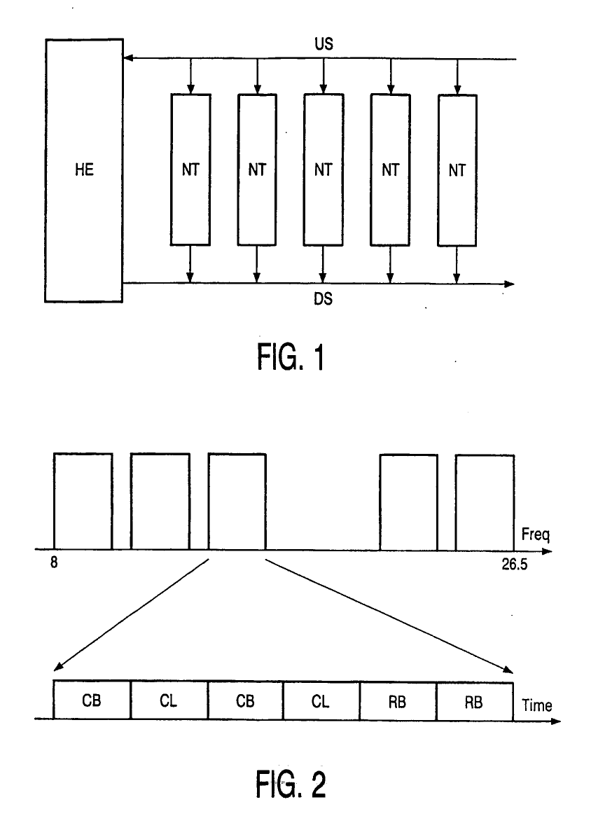

FIG. 1 schematically illustrates a simplified hybrid fibre/coaxial network embodying the invention;

FIG. 2 illustrates slots in a frequency-division multiple access network;

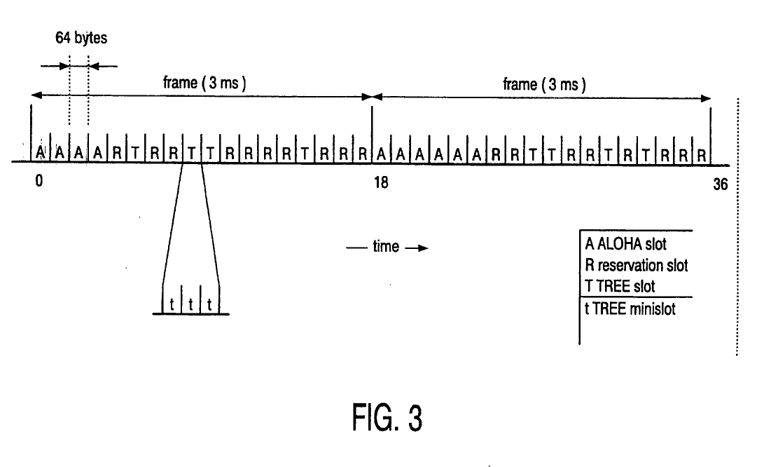

FIG. 3 illustrates the structure of an upstream slot in the network of FIG. 2;

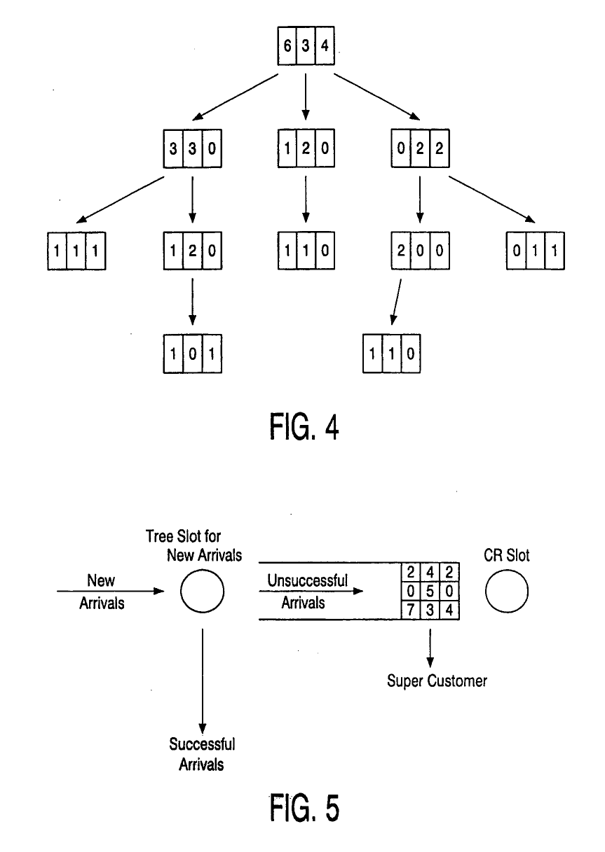

FIG. 4 is a diagram of tree expansion in a contention tree algorithm; and

FIG. 5 illustrates a distributed queue within an embodiment of the invention.

This embodiment is implemented in a cable television system.

Cable television networks (also known as hybrid fibre/coaxial (HFC) networks) were originally designed for broadcasting analogue TV signals downstream (DS) from a central head-end (HE) to subscribers'homes and offices. At present, HFC networks are being upgraded to enable the provision of bi-directional, digital communication services between the subscriber and the HE. Besides the installation of return amplifiers in the upstream (US) path from the subscriber to the HE, active network terminations (NTs) which separate the public network from the provider's private network are required to provide the necessary functionality to support these services. In the mean time, several standards are being developed to ensure interoperability between a HE and a set of NTs that may originate from more than one vendor.

The HFC network architecture represents one of the main access platforms proposed to deliver real-time and non real-time multimedia to residential and business users. Different applications such as telephony and cable television, are at present supported by different access networks but it is likely that these will converge into a single infrastructure that is able to connect users to service and content providers over a single medium. HFC networks have been realized with segments of coaxial cable connecting a main link to buildings in small domain. Bi-directional amplifiers enable a broadcast tree topology to be provided, with frequency-spaced downstream and upstream channels.

The HE manages the downstream bandwidth, while the upstream channels are subject to multiple accesses by the active users. In order to coordinate the upstream transmission, an efficient MAC protocol must be adopted. Different protocols have been proposed by the international organizations, such as the ones confirming to the specification of IEEE 802.14, DOCSIS and DAVIC/DVB. Both IEEE 802.14 and DVB/DAVIC protocols are “ATM friendly”, meaning that the transmission of data takes place in ATM cells. DOCSIS, on the other hand, is primarily aimed at supporting IP-based services. Considering the DAVIC 1.3 specifications, the upstream band is characterized by a narrow band ranging from 8 MHz-26.5 MHz. The cable upstream band is divided into frequency-division multiple access (FDMA) channels whose frequency occupation can be chosen from the set {0.2, 1, 2}MHz, allowing to reach a channel capacity of 0.256, 1.544 and 3.088 Mb/s, respectively since quadrature phase shift keying (QPSK) modulation is used. Each FDMA channel is time-division multiplexed among the terminals assigned to that channel.

In a typical configuration, the terminals range from a few hundred to few thousand in number and are located at different distances from the HE, up to a distance of 80 km. It is assumed that a synchronization method called ranging has been implemented such that all the user terminals appear to have the same distance from the HE. As a result, the propagation delay of data, upstream as well as downstream, is constant and independent of the particular transmitting or receiving terminal.

FIG. 1 illustrates schematically a simplified HFC system. It consists of a single HE and a number of NTs connected by one DS and one US channel. Each NT serves a single connection. It is noted that industry standards support a number of DS channels and a number of US channels per DS channel. It is, however sufficient, for describing the embodiment to consider only one such channel in each direction. Furthermore, an NT is typically capable of supporting more than one connection. The physical organization of the network is such that the NTs cannot communicate with each other directly, but can do so by means of the HE. The HE and each NT executes a software system to implement the method and protocol embodying the invention.

The two channels occupy different frequency bands, so that they do not interfere with one another. The US channel information must be explicitly returned to the NTs by the HE. Access to the channel is by TDMA, with the exception that in the US direction, data can be transmitted in contention at dedicated instants. At such instants, collisions can occur if more than one NT simultaneously transmits data. It is furthermore assumed that the network does not introduce errors such as data corruption or data loss.

As discussed, each NT sends data to the HE in frames. Each frame in this embodiment includes eighteen data slots. For example, the DAVIC standard (DAVIC 1.3 Specifications: Part 8—Lower Layer Protocols and Physical Interfaces, Revision 6.2) is base on a combination of contention-based, contention-less and reservation based time slot assignment. The standard does not specify how many slots within the frame have to be reserved for contention-less and contention-based slots. The structure of such a frame is shown in FIG. 2.

The slots illustrated in FIG. 2 are as follows:

Contention-Less (CL) slots: These slots are assigned by the HE to NTs according to a reservation scheme. An NT connected to the network can only send access requests in those contention-less slots that are reserved for use by it. For example, slots may be assigned to each NT according to a slot-list or cyclic assignment base as described in the DAVIC standard.

Contention-Based (CB) slots. Active NTs can randomly access these slots without any allocation or reservation. Because access is random, collisions occur.

Reservation-Based (RB) slots. These slots are available when a request for extra time slots comes from an active NT. In this case, the request message is sent in a CB slot and, upon positive notification from the HE, the terminal can use the assigned slots for no longer than a frame. (The request might also be sent in a CL slot, but this may be a less efficient alternative.)

The efficiency of the architecture heavily depends on the contention resolution algorithm (CRA), adopted to coordinate retransmissions of collided slots in the case of CB access to the channels.

In this embodiment, the length of the slot corresponds to transmission of a 64-byte packet. This packet comprises of an ATM cell plus physical overhead such as guard bands, a preamble used for demodulation and forward error control. Considering CB slots alone, the DAVIC standard specifies two types of contention slots, namely ALOHA slots and tree slots. The tree slot is further subdivided into three equal-size mini-slots. The slots and mini-slots are used to transmit cells and mini-cells respectively. The slotted upstream transmission time is structured into frames of fixed length. The frame length is equal to 18 slots. The type of each slot in the frame is determined by the HE dynamically on a frame-by-frame basis. FIG. 3 illustrates the organization of the various types of slot within a frame.

The conventional multiple-access contention tree algorithm will now be described. A large number of NTs share a single, slotted broadcast channel, such as that described above. The NTs that contend for channel access are able to acquire ternary feedback on what happened during a contention slot, i.e. whether zero transmissions occurred (an empty slot), one transmission occurred (that was successful) or more than one transmission was attempted (there was a collision) during a particular slot. The ternary feedback can either be detected by the NTs themselves or by a central controller and may not be immediate; that is to say, there may be a delay between the transmission during the contention slot and the reception of the feedback. Furthermore, the tree has a nodal degree m>2, and therefore m consecutive contention slots are grouped into a contention frame. That is to say, there are m mini-slots in a contention slot. The conventional contention tree-algorithm utilizes the ternary feedback as follows. Assume that there are n contending NTs at the start of a new tree algorithm, that is, n NTs want to broadcast a data packet. During the first contention frame (the frame at the root of the tree) each of the n NTs picks at random a number (say k) between 1 and m, with equal probabilities and transmits its packet during the k^{th} contention slot. After completion of the contention frame, the ternary feedback becomes available. Each transmitter then knows whether its packet has been successfully broadcast. If not, a new contention frame is assigned to all transmitters that experienced collision during the particular slot. If there were collisions in all the contention slots, m new contention frames are made available. This leads to the formation of a tree with nodal degree m. The expansion of the tree stops whenever there is either an empty or a successful slot. Upon completion of the tree algorithm, all the n contending NTs will have successfully broadcast their data. Thereafter, a new tree might start again if there are contenders again. An example contention tree with m=3 mini slots per contention slot and the number of NTs is n=13. The number in each mini slot indicates the number of NTs who have transmitted in the corresponding mini slot. If the number is larger than 1 (collision) a new slot consisting of three mini slots is assigned to the NTs involved. If this number is 0 (an empty slot) or 1 (successful) the tree expansion stops. The allocation of NTs to the tree, and expansion of the tree, is illustrated in FIG. 4.

It has been shown that in. case of Poisson generated data packets, the maximum throughput of the binary (m=2) contention tree-algorithm equals 0.347 packets/slot. It has also been demonstrated that if the number of contention slots in the root frame is allowed to be vary, but all other frames still contain two slots, the maximum throughput equals 0.43 packets/slot. The most efficient contention tree-algorithm demonstrated so-far leads to a maximum capacity of 0.487 packets/slot, again in the case of Poisson generated data packets.

Apart from the channel utilization, the access delay (i.e. the time it takes before the data packet has been successfully transmitted) is also an important performance parameter. In order to minimize the access delay, one must take into account the round-trip delay between the transmission of the packet and the reception of the feedback. If the round-trip delay is negligibly small, it is advantageous to perform a serial search, in which each branch of the tree is fully completed before returning to the root. However, in communication channels with a large round trip delay, it may be advantageous to perform a parallel tree search, in which all the contention frames at a certain level are executed before proceeding to the next level. The working of the contention tree protocol as implemented in the DAVIC standards will now be discussed.

There are two types of trees, called blocked trees and free access trees. In a blocked tree, a tree is initiated by transmitting the tree grant to all NTs. This grant is associated with one tree slot, i.e., three successive tree mini-slots. This tree slot forms the root of the tree. When the user terminal decides to transmit a request using a tree, it waits for the root of the tree. Then it chooses a random value w from the set {1, 2, . . . , e}, where e is called the entry spreading. This entry spreading is under the dynamic control of the HE and applies here only to the root of the tree. If w<m (m=3, in this case) then the user terminal chooses the W^{th} tree mini-slot in the tree slot. Otherwise, it has to wait for the root of the next tree and repeat the above procedure again.

The expansion of the tree, i.e., the formation of the rest of the tree, then proceeds recursively. For each collision in the tree mini-slot, a subtree is initiated in which only those NTs that were involved in that collision are allowed to participate. This stipulation is characteristic of a blocked tree. Retransmissions are done in the same way as in the root of the tree, but with e=3, so that the NTs do not “fall off the tree” prematurely. Multiple trees may coexist at the same time.

The non-blocked or free access tree differs from the blocked tree in that the user terminals are allowed to enter the tree at any node. When entering the tree, entry spreading is used as described above. For implementation purposes, if the feedback for a tree mini-slot indicates a collision, a unique group number accompanies this feedback, and the NTs must remember this number. Each NT waits until it receives a tree grant from the HE for its group identified by number. Unlike the ALOHA protocol, the contention-tree feedback need not be relayed on a frame-by-frame basis. As a result, the HE transmits the feedback downstream to the user terminals immediately upon inspecting the contents of the tree mini-slot.

In embodiments on this invention, at least two slots of the (say, eighteen) slots in a frame are reserved for contention access and out of these two slots one slot is reserved for new arrivals and other is reserved for contention resolution if there is a collision in the arrival slot. Therefore, the arrival slot is also a tree access slot with three mini-slots and the procedure for accessing that slot is the same as explained above.

The access method embodying the invention considered here is a distributed queue where one super-customer in the queue refers to more than one NT in either or all of the three mini-slots that collided in the arrival slot. (In this specification, the terms “super-customer” and “group” are used synonymously.) Arrival into the distributed queue happens if and only if there is a collision in any of the three mini-slots of the arrival slot. If there was a collision in the arrival slot of a frame, the collisions within the mini-slot are grouped and considered as one customer in the queue. The distributed queue is shown in FIG. 5.

In FIG. 5, the first super-customer composition is designated [2, 0, 4] which means that there were two collisions in the first arrival tree mini-slot, either no arrival or a successful transmission in the second arrival mini-slot and four arrivals in the third arrival mini-slot. The CR slot in FIG. 4 has three tree slots with each tree slot having three mini-slots. The service time of the customer to the above queue is the execution of the contention tree-algorithm explained above. As shown in the FIG. 4, the second super-customer ([4, 5, 3]) is not served until the contention of the first super-customer ([2, 0, 4]) is resolved.

The performance of this embodiment will now be considered. This assumption simplifies the protocol to a simple queuing mechanism. When a queuing analysis method is used to determine the throughput of the channel and waiting times of the arbitrary customers, it has been found to be more effective than known protocols.

A distributed queue will be described to analyse the performance of the contention tree resolution and study its performance. The advantage of the above formulation is that one can easily evaluate the throughput of the system and evaluate the delay suffered by an arbitrary customer. One can easily think of remedies to improve the performance of the system as there numerous proposals have been made to optimise the performance of a queue.

It is also possible to consider the effect of varying the number of CB slots that are reserved exclusively for new arrivals and the number that are reserved for contention resolution. It is also possible to generalise this comparison to S slots reserved for new arrivals and N slots for contention resolution, and attempt to determine the optimal values of S and N for which the performance of the system can be maximized.

If there were exactly one arrival in each of the three mini-slots, then there would be no contention and the tree protocol would terminate with the root node itself. In embodiments of this invention, the root node of the tree is the arrival slot. Normally users access those slots at random, so in conditions in which frequent requests are being received, it is highly likely that there will be contention in one or more of the three mini-slots. As explained above, there is a group feedback and the users who collided in a particular mini-slot are only allowed to access the new slot reserved for contention resolution. The users who collided in the arrival slot are grouped together and sent into a queue, which in this example is a simple FIFO queue, so that this group alone attempts transmission at in turn. As shown in FIG. 5, the first super customer is a combination 2,0,4. Therefore, two customers enter the first mini-slot, the second mini-slot is not used and the third mini-slot has four customers entering. Now the tree proceeds starting to resolve the first mini-slot and then coming to the third mini-slot. The second mini-slot is skipped as it has no customers. Also the requests belonging to a particular group choose one of the three mini-slots randomly in the tree algorithm, so the service completion of a particular group means the completion of a single free access tree process. Therefore, the service time of a super customer is the termination time of the tree. Since there is exactly one slot reserved for tree access per frame, we can get a customer at that initiation of a frame or we may not get a customer. (Here, the term “customer” is used to refer to a group that collided in the arrival slot of the tree.) Arrivals are modelled to be geometrically distributed wherein a frame may generate a customer or not. The service time is assumed to be general distribution and so we get a simple Geom/G/1 queue.

Some notation must first be introduced. Let B be a random variable that represents the service time distribution of an arbitrary super customer (measured in slots, not frames), E is the expectation operator, ES represents the mean service time and ES² represents the second moment of the service time which is important to determine the variance.

Define π(n) as the probability that an arbitrary super customer is of size n, i.e., it consists of n individual customers, n>2. Let B(n) be a random variable representing the service time distribution of a super customer of size n, n>2. Then it can be shown that the arrival probability is distributed as:

$$P \{ B ( 2 ) = k \} = \frac{2}{3} {( \frac{1}{3} )}^{k - 1} , k = 1 , 2 , …$$

and that the mean waiting time of a super customer is

$$E [ W ] = \frac{λ}{1 - ρ} \cdot \frac{E [ {B}^{2} ] - E [ B ]}{2}$$

where the arrival of individual customers is Poisson with rate □ and ρ=λEB.

Therefore, the waiting time of the individual customer is independent of how the tree is run (either breadth-first resolve or depth-first resolve). However, the sojourn time in the system depends on how the tree is resolved.

Simulation results of the sojourn time analysis for different tree disciplines are given in Tale 1 below in comparison with conventional gated and free access systems. The sojourn time is the addition of waiting time and the service time spent by a typical customer. The waiting times are present only for the gated and the proposed model. It is not present in the free access mechanism as new customers join the tree immediately on their arrival. For comparison analysis, the sojourn time is very important.

TABLE 1

| | λ = 1.09 | | λ = 1.15 | | λ = 1.20 | |
|---|---|---|---|---|---|---|
| Mechanism | ES | ES² | ES | ES² | ES | ES² |
| Gated | 30.8638 | 3394.5421 | | | | |
| Free Access | 7.2378 | 191.9586 | 15.3343 | 945.7694 | 176.2111 | 124109.3 |
| s = 1 | 8.4828 | 211.3771 | 16.5165 | 872.6557 | 204.8015 | 142976.19 |
| s = 2 | 7.5666 | 115.6625 | 11.4232 | 295.4935 | 23.0804 | 1365.9587 |

As can be seen from Table 1, the system provided by the invention performs well in heavy traffic, and during light traffic wastes relatively few slots.

It is also possible to calculate the capacity of a channel that uses an access method embodying the invention. This can be shown to be in accordance with the following formula:

$${α}_{λ} {EB}_{λ} = {α}_{λ} {B}_{λ}^{′} ( 1 ) = [ 1 - {{ⅇ}^{- λ} ( 1 + \frac{λ}{3} )}^{3} ] {B}_{λ}^{′} ( 1 ) < s$$

The results of the capacity analysis are compared with the conventional gated and free access mechanisms are given in Table 2 below. For the sake of analysis a general q-ary tree is considered instead of a 3-ary tree as described in relation to the embodiment above.

TABLE 2

| Mechanism | q = 2 | q = 3 | q = 4 |
|---|---|---|---|
| Gated | 0.3466 | 0.3662\ | 0.3466 |
| Free Access | 0.360 | 0.4 | 0.4 |
| S = 1 | 0.420 | 0.4012 | 0.368 |
| S = 2 | 0.427 | 0.4132 | 0.378 |
| S = 3 | 0.419 | 0.4080 | 0.374 |
| S = 4 | 0.410 | 0.4017 | 0.369 |

It is easily seen that the queuing model provided by this invention can offer performance that is superior to existing models. It can also be inferred that the free access mechanism outperforms other mechanisms when q=4. The mechanism of the invention outperforms these other two mechanisms if s=2 and q=3. Therefore, it is advantageous in embodiments of the invention to set aside one slot for new arrivals and two slots for contention resolution from a frame of 18 slots.

The main reason for such this performance advantage is that there are small trees in the proposed system as compared with the large trees that are present in existing mechanisms under heavy traffic conditions.

1. A method of contention resolution in a medium access control system in which medium data is transmitted in frames, each comprising a plurality of slots, in which at least two slots in each frame are contention slots in which at least one contention slot in each frame is reserved for new arrivals to a contention tree that wish to access the channel capacity using contention resolution and that and in which at least one further contention slot is reserved for resolving contention if there is collision in the arrival slot.

2. A method according to claim 1 in which any arrivals that collided in a particular arrival slot are only allowed to access the contention slot.

3. A method according to claim 1 in which the number of arrival slots is unequal to the number of contention slots.

4. A method according to claim 3 in which the number of contention slots is greater than the number of arrival slots.

5. A method according to claim 3 in which the number of contention slots is greater than the number of arrival slots by a factor of 2 or more.

6. A method according to claim 3 in which a frame has a total of eighteen slots and there is one arrival slot and two contention slots for contention resolution.

7. A method according to claim 1 in which each arrival and contention slot comprises a plurality of mini-slots.

8. A method according to claim 7 in which each arrival and contention slot comprises three mini-slots.

9. A method according to claim 1 in which requests that collided in the arrival slot are grouped together as a super customer and sent into a queue.

10. A method according to claim 9 in which the queue is a simple FIFO queue.

11. A method according to claim 9 in which requests that collided in the arrival slot are transferred to a contention slot.

12. A method according to claim 11 in which mini-slots that contain at least one request in the contention slots are processed in turn.

13. A method according to claim 1 for controlling an upstream link in a public-access content distribution system.

14. A method according to claim 13 in which the public-access content distribution system is a HFC cable distribution system.

15. A medium access protocol that performs contention resolution by a method according to claim 1.

16. A medium access protocol according to claim 15 for granting access to an upstream link in a HFC cable distribution system.

17. A public-access content distribution system comprising a head end and a plurality of network terminals, upstream communication between the network terminals and the head end being controlled by a protocol according to claim 15.

18. A software system executable by the head end of a communication system for performing a medium access protocol according to claim 15.
